(19) United States
(12) Patent Application Publication
(10) Pub. No.: US 2025/0182975 A1
(43) Pub. Date: Jun. 5, 2025

(54) SOLID ELECTROLYTIC CAPACITOR AND METHOD OF MANUFACTURING SOLID ELECTROLYTIC CAPACITOR

(71) Applicant: Murata Manufacturing Co., Ltd., Nagaokakyo-shi (JP)

(72) Inventors: Katsutomo ARITOMI, Nagaokakyo-shi (JP); Yoshimasa YOSHINO, Nagaokakyo-shi (JP)

(21) Appl. No.: 19/048,237

(22) Filed: Feb. 7, 2025

Related U.S. Application Data
(63) Continuation of application No. PCT/JP2023/030502, filed on Aug. 24, 2023.

(30) Foreign Application Priority Data
Aug. 31, 2022 (JP) 2022-138118

(51) Int. Cl. H01G 9/012; H01G 4/30; H01G 9/042; H01G 9/10

(52) U.S. Cl. CPC H01G 9/012; H01G 4/30; H01G 9/042; H01G 9/10

(57) ABSTRACT

A solid electrolytic capacitor including: a plurality of capacitor elements, each capacitor element having: a flat film-shaped main body including a valve metal, a dielectric layer on the main body, and a solid electrolyte layer on at least a part of the dielectric layer so as to define a cathode formation region having the solid electrolyte layer and an anode terminal region that does not include the solid electrolyte layer; a sealing body sealing the plurality of capacitor elements, the sealing body having a first end surface at which an end portion of an anode terminal region is exposed; a first base electrode on the first end surface and including a first element; and a second base electrode covering the first base electrode and including the first element and a second element, wherein the second base electrode is an intermetallic compound of the first element and the second element.

### CROSS REFERENCE TO RELATED APPLICATIONS

The present application is a continuation of International application No. PCT/JP2023/030502, filed Aug. 24, 2023, which claims priority to Japanese Patent Application No. 2022-138118, filed Aug. 31, 2022, the entire contents of each of which are incorporated herein by reference.

### TECHNICAL FIELD

The present disclosure relates to a solid electrolytic capacitor including a lead frame as an external electrode.

### BACKGROUND ART

Patent Literature 1 discloses a solid electrolytic capacitor including a capacitor element and a sealing member made of a resin that seals the capacitor element and forming a sealing body (an insulating resin body) by sealing this capacitor element. In this solid electrolytic capacitor, a cathode terminal and an anode terminal each are led out from the capacitor element to the outside of the sealing body by a lead frame, and each terminal functions as an external electrode.

This solid electrolytic capacitor includes a plurality of capacitor elements. Each of the capacitor elements includes an electrode foil, a dielectric layer, and a solid electrolyte layer.

A surface layer portion of the electrode foil is a porous body. The dielectric layer is formed on a surface of the porous body. The solid electrolyte layer is formed in a portion in which the dielectric layer on the surface of the electrode foil is formed.
[Patent Literature 1] International Publication No. 2020/179170

### BRIEF SUMMARY OF THE DISCLOSURE

The lead frame in the solid electrolytic capacitor disclosed in Patent Literature 1 is internally formed. This lead frame is embedded in the insulating resin body, and a part is exposed from both end surfaces of the insulating resin body and formed over both the end surfaces and the bottom surface. The lead frame embedded in the insulating resin body is welded to the capacitor element. That is to say, this welded portion is used as a welding margin and functions as an electrode of the solid electrolytic capacitor.

However, this welding margin reduces a function volume ratio of the solid electrolytic capacitor. On the other hand, when this welding margin is reduced, the capacitor element and the lead frame are unable to be reliably connected, which may cause poor contact. Moreover, even when the size of the capacitor element is increased in order to make a function volume ratio increase, a chip size as a solid electrolytic capacitor is increased accordingly.

The function volume ratio in the present disclosure is defined as follows. The function volume ratio is a ratio of a volume of a portion that functions as a capacitor to a volume of a solid electrolytic capacitor. That is to say, an increase in this function volume ratio achieves a larger electrostatic capacity in the determined size of the outer shape of a solid electrolytic capacitor.

In view of the foregoing, exemplary embodiments of the present disclosure are directed to provide a solid electrolytic capacitor capable of increasing a function volume ratio and achieving high reliability.

A solid electrolytic capacitor according to the present disclosure includes: a plurality of capacitor elements, each capacitor element having: a flat film-shaped main body including a valve metal, a dielectric layer on the flat film-shaped main body, and a solid electrolyte layer on at least a part of the dielectric layer so as to define a cathode formation region having the solid electrolyte layer and an anode terminal region that does not include the solid electrolyte layer; a sealing body sealing the plurality of capacitor elements, the sealing body having a first end surface at which an end portion of the anode terminal region is exposed; a first base electrode on the first end surface and including a first element; and a second base electrode covering the first base electrode and including the first element and a second element, wherein the second base electrode is an intermetallic compound of the first element and the second element.

In this configuration, a capacitor multilayer body is able to be formed by welding a plurality of capacitor elements to a first base electrode and a second base electrode that are formed on a first end surface. That is to say, the welding margin to connect a lead frame and a capacitor element is unnecessary, which makes it possible to increase a region of the capacitor element in which the dielectric layer and the solid electrolyte layer are formed. Therefore, a function volume ratio is able to be improved without increasing a size of the solid electrolytic capacitor.

A method of manufacturing a solid electrolytic capacitor according to the present disclosure includes: forming a capacitor element having: a flat film-shaped main body including a valve metal, a dielectric layer on the flat film-shaped main body, and a solid electrolyte layer on at least a part of the dielectric layer so as to define a cathode formation region having the solid electrolyte layer and an anode terminal region that does not include the solid electrolyte layer; forming a sealing body by stacking a plurality of the capacitor elements and sealing the plurality of capacitor elements with an insulating resin, the sealing body having a first end surface at which an end portion of the anode terminal region is exposed; forming a first base electrode on the first end surface, the first base electrode including a first element; forming a third base electrode covering at least a part of the first base electrode, the third base electrode including a second element; forming a first terminal electrode covering at least a part of the third base electrode, the first terminal electrode including the first element; and heating and pressing the first terminal electrode on the first end surface on which the third base electrode is formed so as to cause the first base electrode and the third base electrode react with each other and the first terminal electrode and the third base electrode react with each other to form a second base electrode including the first element and the second element.

A second base electrode including the first element and the second element is formed by heating and pressing the first terminal electrode on the first end surface on which the third base electrode is formed, making the first base electrode and the third base electrode react with each other, and also making the first terminal electrode and the third base electrode react with each other.

In this manufacturing method, the welding margin to connect a lead frame and a capacitor element is unnecessary, which makes it possible to increase a region of the capacitor element in which the dielectric layer and the solid electrolyte layer are formed. In addition, the second base electrode is formed by making the first base electrode and the third base electrode react with each other and also making the first terminal electrode and the third base electrode react with each other, which makes it possible to reliably connect the capacitor element and the lead frame without requiring a welding step to connect the capacitor element and the lead frame.

According to the present disclosure, a reliable solid electrolytic capacitor capable of increasing a function volume ratio and achieving high reliability is able to be provided.

### BRIEF DESCRIPTION OF THE DRAWINGS

FIG. 1 is a side cross-sectional view of a solid electrolytic capacitor according to a first exemplary embodiment of the present disclosure.

FIG. 2A is a partially enlarged view of a capacitor element according to the first exemplary embodiment, and FIG. 2B is a side cross-sectional view of the capacitor element.

FIG. 3 shows a side cross-sectional view and partially enlarged view of the solid electrolytic capacitor according to the first exemplary embodiment.

FIG. 4A, FIG. 4B, and FIG. 4C are views specifically showing a configuration of an electrode portion.

FIG. 5 is a flowchart showing a procedure of forming the solid electrolytic capacitor according to the first exemplary embodiment.

FIG. 6A, FIG. 6B, and FIG. 6C are views showing an overview to form the solid electrolytic capacitor according to the first exemplary embodiment.

FIG. 7 is a view showing an overview to form an electrode by the AD method in the capacitor element according to the first exemplary embodiment.

FIG. 8A is a side cross-sectional view of the solid electrolytic capacitor of the present disclosure, and FIG. 8B is a side cross-sectional view of a solid electrolytic capacitor in the conventional configuration.

### DESCRIPTION OF EXEMPLARY EMBODIMENTS

### First Exemplary Embodiment

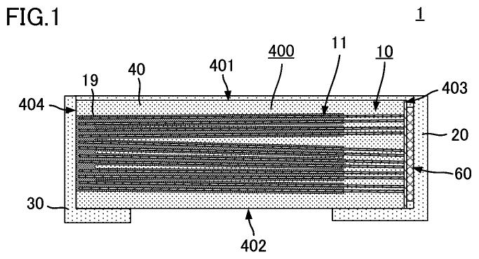

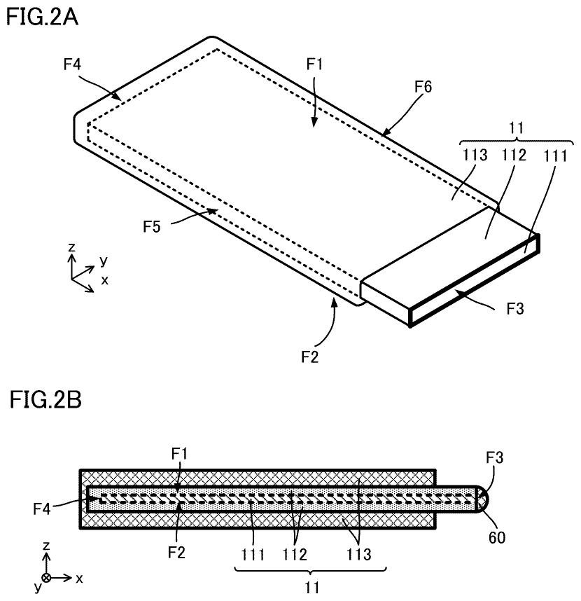

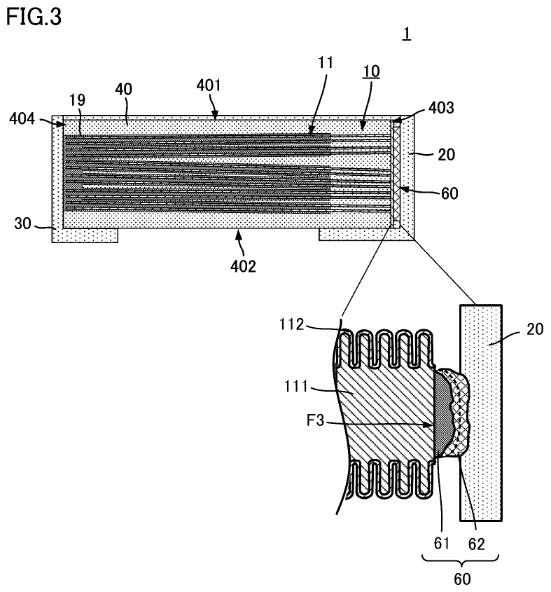

A solid electrolytic capacitor according to a first exemplary embodiment of the present disclosure will be described with reference to the drawings. FIG. 1 is a side cross-sectional view of the solid electrolytic capacitor according to the first exemplary embodiment of the present disclosure. FIG. 2A is a perspective view of the capacitor element according to the first exemplary embodiment, and FIG. 2B is a side cross-sectional view of the capacitor element. FIG. 3 shows a side cross-sectional view and partially enlarged view of the solid electrolytic capacitor according to the first exemplary embodiment.

### (Structure of Solid Electrolytic Condenser)

A solid electrolytic capacitor 1 includes a capacitor assembly 10, a first terminal electrode 20, a second terminal electrode 30, an insulating resin body 40, and an electrode portion 60. The first terminal electrode 20 and the second terminal electrode 30 correspond to external electrodes of the present disclosure.

The capacitor assembly 10 includes a plurality of capacitor elements 11 and a conductive member 19. The conductive member 19 is preferably an electrode paste mainly composed of nickel, silver, or copper, for example. The maximum thickness of the conductive member 19 is preferably 2 μm to 20 μm. It is to be noted that the conductive member 19 is able to be omitted as long as conductivity more than a desired conductivity is obtained between the plurality of capacitor elements 11 and the second terminal electrode 30.

Moreover, in the present exemplary embodiment, the number of capacitor elements 11 that configure the capacitor assembly 10 may be two or more and has no limitation. It is to be noted that the details of the capacitor element 11 will be described below.

The plurality of capacitor elements 11 are stacked on each other. The capacitor assembly 10 is formed by stacking the plurality of capacitor elements 11. At this time, the plurality of capacitor elements 11 are formed so as to be substantially in parallel with each other.

The capacitor assembly 10 is sealed with the insulating resin body 40. This forms a sealing body 400. The sealing body 400 has an approximately rectangular parallelepiped shape having a top surface 401, a bottom surface 402, a first end surface 403, and a second end surface 404.

At this time, a part of the plurality of capacitor elements 11 is exposed from the first end surface 403 of the sealing body 400. The surface (the first end surface 403) on which the plurality of capacitor elements 11 are linearly exposed from the insulating resin body 40 is connected to the first terminal electrode 20 through the electrode portion 60.

The first terminal electrode 20 is formed in accordance with the sealing body 400. Specifically, the first terminal electrode 20 is disposed over the first end surface 403 and the bottom surface 402 of the sealing body 400.

A connection layer (a conductive layer including the solid electrolyte layer 113) of the plurality of capacitor elements 11 is electrically and physically connected to the second terminal electrode 30 by the conductive member 19. This conductive member 19 is formed so as to be exposed from the sealing body 400.

As with the first terminal electrode 20, the second terminal electrode 30 is formed in accordance with the sealing body 400. Specifically, the second terminal electrode 30 is disposed over the second end surface 404 and the bottom surface 402.

The first terminal electrode 20 and the second terminal electrode 30 are preferably formed of, for example, a metal material that is a Cu alloy (a copper alloy) material or an iron alloy material and is easily bent and has high conductivity. The first terminal electrode 20 and the second terminal electrode 30 are formed of, for example, a material cut out from a metal plate material. It is to be noted that the first terminal electrode 20 and the second terminal electrode 30 may be formed of the same material or may be formed of a different material.

The insulating resin body 40 is mainly made of a resin and may include a filler. The resin preferably includes an epoxy resin, a phenol resin, a polyimide resin, a silicone resin, a polyamide resin, and/or a liquid crystal polymer. The resin is usable in both a solid form and a liquid form. A corner portion is preferably rounded by barrel polishing after resin sealing. The filler preferably includes a silica particle, an alumina particle, a metallic particle, or the like, for example. The maximum diameter of the filler, for example, is preferably 30 μm to 40 μm. A solid epoxy resin and a phenol resin more preferably include a material including a silica particle.

### (Structure of Capacitor Element)

A more detailed structure of the capacitor element 11 will be described with reference to FIG. 2A and FIG. 2B.

FIG. 2A is a perspective view of the capacitor element, and FIG. 2B is a side cross-sectional view of the capacitor element. FIG. 2B is a cross-sectional view of a surface orthogonal to a flat film surface and an end surface of the capacitor element.

The capacitor element 11 includes an electrode foil 111, a dielectric layer 112, and a solid electrolyte layer 113.

The electrode foil 111 is made of a metal simple substance such as aluminum, tantalum, niobium, titanium, zirconium, magnesium, or silicon, for example, or an alloy containing such metals, or the like. The surface layer portion of the electrode foil 111 is preferably a porous body. It is to be noted that the electrode foil 111 is preferably made of aluminum or an aluminum alloy. The electrode foil 111 may be a valve metal that provides a so-called valve effect.

The dielectric layer 112 is formed on the electrode foil 111. As shown in FIG. 2B, the electrode foil 111 has a first surface F1 and a second surface F2 facing each other in a Z-axis direction. Furthermore, the electrode foil 111 is connected to this first surface F1 and the second surface F2 and includes a third surface F3, a fourth surface F4, a fifth surface F5, and a sixth surface F6 that are parallel to the Z-axis direction. The third surface F3 and the fourth surface F4 are surfaces parallel to a Y-axis direction. In addition, the fifth surface F5 and the sixth surface F6 are surfaces parallel to an X-axis direction. The dielectric layer 112 covers the first surface F1, the second surface F2, the fourth surface F4, the fifth surface F5, and the sixth surface F6 of the electrode foil 111. Moreover, the electrode portion 60 is formed on the third surface F3. This third surface F3 is a portion of the first end surface 403. A structure of the electrode portion 60 will be described below.

The dielectric layer 112 is preferably made of an oxide film of the electrode foil 111. The dielectric layer 112, when an aluminum foil is used for the electrode foil 111, for example, is formed by oxidation treatment in an aqueous solution containing boric acid, phosphoric acid, adipic acid, or those sodium salt, ammonium salt, or the like. The thickness of the dielectric layer 112 is preferably 10 nm to 100 nm.

The solid electrolyte layer 113 covers an outer surface (a surface facing a surface in contact with at least the electrode foil 111) of the dielectric layer 112. The solid electrolyte layer 113 is also filled in the large number of pores covered with the dielectric layer 112.

As a more specific configuration, the solid electrolyte layer 113 includes an inner layer and an outer layer, for example.

The inner layer is a layer near the dielectric layer 112 of the solid electrolyte layer 113 and may be a layer of PEDOT:PSS achieved by a conductive polymer based on pyrroles, thiophenes, anilines, or the like, or PEDOT [poly(3,4-ethylenedioxythiophene)] of a conductive polymer based on thiophenes, or the like and compounded with polystyrene sulfonic acid (PSS) as a dopant. The inner layer is formed by a method of using an electrolytic solution as a base to form the solid electrolyte layer 113, for example, a treatment liquid containing a monomer such as 3,4-ethylenedioxythiophene to form a polymer film such as a poly(3,4-ethylenedioxythiophene) film on the surface of the dielectric layer 112, a method of applying a dispersion liquid of a polymer such as poly(3,4-ethylenedioxythiophene) onto a surface of a dielectric portion and drying the dispersion liquid, or the similar method.

The outer layer is a layer formed outside the inner layer. For example, the outer layer is a layer formed, after the inner layer filling a fine depression of a porous portion is formed, so as to cover the entire inner layer. The thickness of the outer layer is preferably 2 μm to 20 μm. The outer layer is preferably a carbon layer, a graphene layer, or a silver layer that is formed, for example, by adding conductive paste such as carbon paste, graphene paste, or silver paste. The outer layer may be a composite layer in which a silver layer is provided on a carbon layer or a graphene layer or may be a mixed layer obtained by mixing carbon paste or graphene paste and silver paste.

As a layer further subsequent to the outer layer, a conductive adhesive layer may be provided. A material configuring the conductive adhesive layer may use a mixture of an insulating resin such as an epoxy resin or a phenol resin and a conductive particle such as carbon or silver, for example.

By such a configuration, the capacitor element 11 serves as a flat film-shaped solid electrolytic capacitor. In this capacitor element 11, the electrode foil 111 corresponds to an anode and the solid electrolyte layer 113 corresponds to a cathode. A region in which the solid electrolyte layer 113 in the electrode foil 111 is not formed corresponds to the anode terminal region in the present disclosure, and the solid electrolyte layer 113 corresponds to the cathode formation region of the present disclosure. The electrode foil 111 corresponds to the main body in the present disclosure.

### (Structure of Electrode Portion)

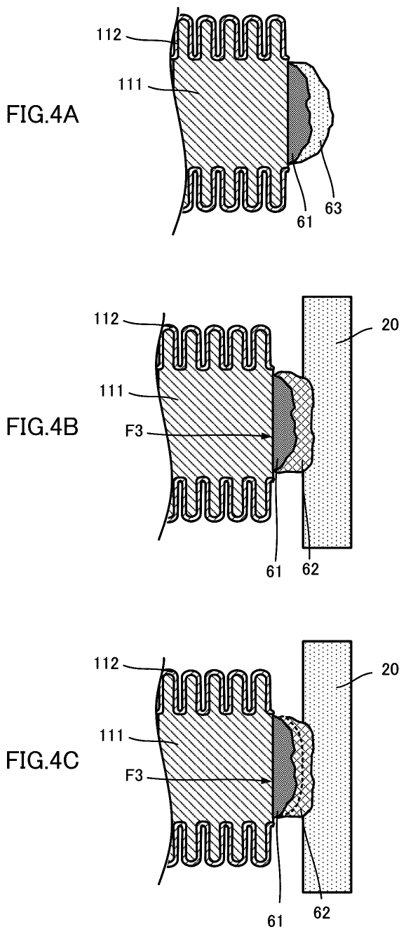

Next, the details of a structure of the electrode portion 60 formed on the third surface F3 will be described with reference to FIG. 3, FIG. 4A, FIG. 4B, and FIG. 4C. As shown in FIG. 3, the electrode portion 60 includes a first base electrode 61 and a second base electrode 62.

The first base electrode 61 is formed on the third surface F3 (the end surface of the electrode foil 111) of the capacitor element 11. The first base electrode 61 is formed in a predetermined thickness (height) from the third surface F3. The first base electrode 61 is a Cu layer formed on the third surface F3 by use of the AD method.

The second base electrode 62 covers at least the first base electrode 61. Accordingly, the first base electrode 61 and the second base electrode 62 project outward from the third surface F3. The first terminal electrode 20 is formed so as to be in contact with the second base electrode 62.

The first terminal electrode 20 is connected to the electrode portion 60 as shown in FIG. 4A, FIG. 4B, and FIG. 4C. A more specific configuration will be described.

First, as shown in FIG. 4A, a Cu layer is formed on the third surface F3 of the capacitor element 11 by use of the AD method. This Cu layer serves as the first base electrode 61. Next, a third base electrode 63 is formed on the first base electrode 61 by use of the AD method. The third base electrode 63 is a Sn layer. It is to be noted that the first element in the present disclosure is Cu configuring the first base electrode 61, and the second element is Sn configuring the third base electrode 63.

Next, as shown in FIG. 4B, the first terminal electrode 20 is formed so as to be in contact with the third base electrode 63. The first terminal electrode 20 is heated and pressed on the third surface F3 on which the third base electrode 63 is formed. Accordingly, heat is transferred to the first base electrode (Cu) 61 and the third base electrode 63, and the first base electrode (Cu) 61 and third base electrode (Sn) 63 melt. That is to say, the Cu layer of the first base electrode 61 and the third base electrode 63 react with each other, which forms an intermetallic compound layer of Cu₃Sn. This intermetallic compound layer of Cu₃Sn is the second base electrode 62.

Similarly, as shown in FIG. 4C, the first terminal electrode 20 and the third base electrode 63 react with each other. As described above, the first terminal electrode 20 is formed of a Cu alloy. That is to say, the third base electrode 63 reacts with the first terminal electrode 20, which forms the second base electrode (the intermetallic compound layer of Cu₃Sn) 62. In other words, the third base electrode 63 forms the second base electrode (the intermetallic compound layer of Cu₃Sn) 62 by eroding to the first terminal electrode 20.

Therefore, the bonding of the first base electrode 61, the second base electrode 62, and the first terminal electrode 20 is strong. Moreover, a specific formation method and a specific shape of electrode portion 60 will be described below.

It is to be noted that FIG. 3, FIG. 4A, FIG. 4B, and FIG. 4C shows an example in which the third base electrode 63 and a portion of the first base electrode 61 react with each other and form the second base electrode 62. However, the third base electrode 63 may remain inside the second base electrode 62. In addition, the third base electrode 63 may remain (between the second base electrode 62 and the first terminal electrodes 20) so as to cover at least a portion of the second base electrode 62.

The above configuration achieves the solid electrolytic capacitor 1.

### (Method of Manufacturing of Solid Electrolytic Capacitor)

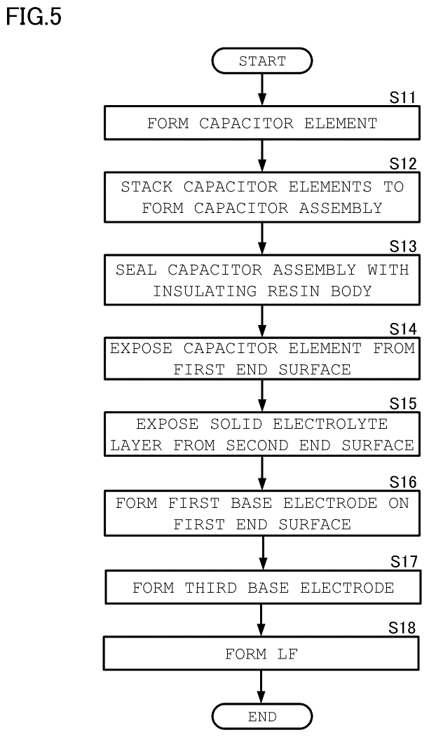

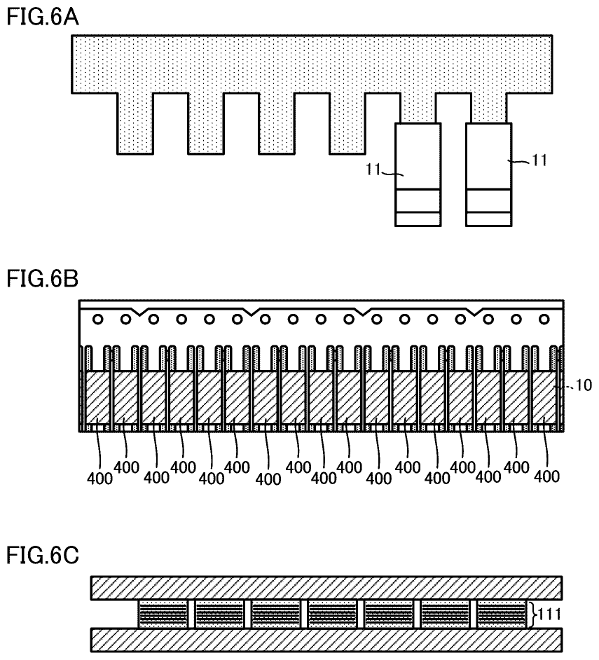

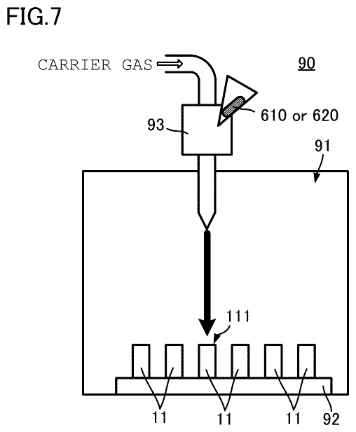

The solid electrolytic capacitor 1 composed of the above configuration is manufactured as follows, for example. FIG. 5 is a flowchart showing an example of a schematic flow of the method of manufacturing the solid electrolytic capacitor according to the present exemplary embodiment. FIG. 6A, FIG. 6B, and FIG. 6C are views in respective process steps showing a state of the solid electrolytic capacitor according to the present exemplary embodiment. FIG. 7 is a view of a device of forming a base electrode by the AD method.

A capacitor element 11 is formed (S11). Specifically, as shown in FIG. 2A, FIG. 2B, and FIG. 6A, a dielectric layer 112 and a solid electrolyte layer 113 are formed on and around a plurality of electrode foils 111.

Next, a conductive member 19 is formed at the solid electrolyte layer 113 of the capacitor element 11. Furthermore, the capacitor elements 11 are stacked on each other to form a capacitor assembly 10 (S12).

The capacitor assembly 10 is sealed with an insulating resin body 40 (S13). Specifically, as shown in FIG. 6B, a plurality of capacitor assemblies 10 are stacked on each other and this capacitor assembly 10 is sealed with the insulating resin body 40, which forms a sealing body 400.

Next, the first end surface 403 (the electrode foil 111) in the capacitor element 11 is exposed (S14). More specifically, as shown in FIG. 6C, the sealing body 400 is fixed and is ground so that the electrode foil 111 of the first end surface 403 may be linearly exposed.

Similarly, the second end surface 404 (the solid electrolyte layer 113) in the capacitor element 11 is exposed (S15). It is to be noted, in a case in which the sealing body 400 is formed so that the solid electrolyte layer 113 may be exposed, Step S15 is able to be skipped.

Next, a first base electrode 61 is formed on the electrode foil 111 exposed in Step S12 (S16).

More specifically, as shown in FIG. 7, the sealing body 400 that exposes a plurality of capacitor elements 11 is fixed on a stage 92 and is disposed in a chamber 91. At least a front end (a jet end) of an aerosol generator 93 is inserted into the chamber 91. The aerosol generator 93, by introducing copper powder (Cu powder) 610 into carrier gas, generates aerosol and sprays the aerosol on the first end surface 403 of the sealing body 400. At this time, a specification (a volume ratio of copper powder 610 included in the carrier gas, or the like, for example) of the aerosol and a spray condition (the number of times of spraying, spraying strength, or the like, for example) are properly set, so that the copper powder 610 is piled up in a predetermined height (a predetermined thickness) on mainly the third surface F3 of the plurality of electrode foil 111 and forms the first base electrode 61. It is to be noted that, at this time, a particle diameter of the copper powder 610, although being approximately 3 μm, for example, may be 2 μm or less.

Next, a third base electrode 63 is formed by use of the AD method on the first base electrode 61 formed in Step S16 (S17).

More specifically, as shown in FIG. 7, the sealing body 400 at which the first base electrode 61 is formed is fixed on the stage 92 and is disposed in the chamber 91. At least the front end (the jet end) of the aerosol generator 93 is inserted into the chamber 91. The aerosol generator 93, by introducing Sn powder into carrier gas, generates aerosol and sprays the aerosol on the first end surface 403 of the sealing body 400 and the first base electrode 61. At this time, a specification (a volume ratio of Sn powder 620 included in the carrier gas, or the like, for example) of the aerosol and a spray condition (the number of times of spraying, spraying strength, or the like, for example) are properly set, so that the Sn powder 620 is piled up in a predetermined height (a predetermined thickness) on mainly the third surface F3 of the plurality of electrode foil 111 and the first base electrode 61 and forms the third base electrode 63.

Next, a first terminal electrode 20 is formed on the first end surface 403, a second terminal electrode 30 is formed on the second end surface 404, and a lead frame (LF) is formed with respect to the solid electrolytic capacitor 1 (S18). More specifically, the first terminal electrode 20 and the second terminal electrode 30 are brought into contact with the sealing body 400 and heated and pressurized.

As described above, the first base electrode 61 and the third base electrode 63 are formed so as to have irregularities by use of the AD method (see FIG. 4A). That is to say, the first base electrode 61 and the third base electrode 63 are more firmly bonded to each other according to an anchor effect. As shown in FIG. 3, FIG. 4A, FIG. 4B, and FIG. 4C, heat is applied to the first terminal electrode 20 and then heat is applied to the first base electrode 61 and the third base electrode 63, so that an intermetallic compound (Cu₃Sn) is formed in a region in which the first base electrode 61 and the third base electrode 63 are in contact with each other. This intermetallic compound (Cu₃Sn) is the second base electrode 62, and the electrode foil 111 and the first terminal electrode 20 are electrically and physically connected through the first base electrode 61 and the second base electrode 62. In particular, the intermetallic compound is formed, which improves the bonding strength. Similarly, the second terminal electrode 30 is connected to the capacitor element 11 through the conductive member 19.

It is to be noted that, in a case in which a width of the lead frame is smaller than a width of the sealing body 400, a sealing resin may be further applied to a portion that is not covered with the lead frame of each end surface of the sealing body 400 to significantly reduce moisture from penetrating inside the sealing body 400. In addition, as shown in the enlarged view of FIG. 3, a slight gap is between a porous body portion (the surface layer portion) of the electrode foil 111 and the lead frame, and the gap may also serve as an intrusion path of moisture. In order to close such an intrusion path of moisture, even when the width of the lead frame is not smaller than the width of the sealing body 400, the sealing resin may be applied to the portion that is not covered with the lead frame of each end surface of the sealing body 400 These treatments are able to improve moisture resistance of the solid electrolytic capacitor 1.

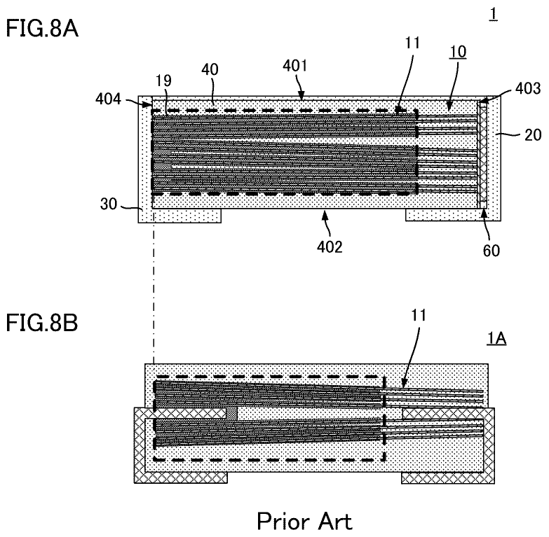

Next, with reference to FIG. 8A and FIG. 8B, a solid electrolytic capacitor 1 formed by use of the above configuration and a solid electrolytic capacitor 1A in the conventional configuration are compared.

FIG. 8A is a side cross-sectional view of the solid electrolytic capacitor 1 showing the configuration in the present disclosure. FIG. 8B is a side cross-sectional view of the solid electrolytic capacitor 1A in the conventional configuration.

When FIG. 8A and FIG. 8B are compared, the function volume ratio in the configuration of the present disclosure is about 1.5 times the function volume ratio in the conventional configuration. More specifically, in FIG. 8A, the first terminal electrode 20 is not formed inside the solid electrolytic capacitor 1, so that the function volume ratio is able to be increased. On the other hand, the outer shape of the solid electrolytic capacitor 1 is the same as the outer shape of the solid electrolytic capacitor 1A, so that the volume of the solid electrolytic capacitor 1 is the same as the volume of the solid electrolytic capacitor 1A.

That is to say, the function volume ratio of a portion that substantially functions as a capacitor is able to be larger than the conventional configuration, without increasing the size of the solid electrolytic capacitor 1. Therefore, in a case in which the size of the solid electrolytic capacitor 1 of the configuration of the present disclosure is the same as the size of the solid electrolytic capacitor 1A, the function volume ratio of the solid electrolytic capacitor 1 is improved.

In addition, the capacitor element 11 and the first terminal electrode 20 are physically and electrically connected by the electrode portion 60. That is to say, the connection between the capacitor element 11 and the first terminal electrode 20 are able to be ensured. In particular, the intermetallic compound is formed at the electrode portion 60, which improves the bonding strength. Therefore, a solid electrolytic capacitor 1 with high reliability is able to be achieved.

It is to be noted that the solid electrolytic capacitor is not limited to a configuration in which a plurality of flat film-shaped capacitor elements are stacked in a thickness direction of the solid electrolytic capacitor, as shown in the above configuration. For example, the solid electrolytic capacitor may have a configuration in which a flat film-shaped capacitor element is wound and stored in a cylinder-shaped housing.

In addition, the configuration and various derived examples shown in each of the above exemplary embodiments are able to be appropriately combined, and advantageous functions and effects according to each combination are able to be obtained.

### REFERENCE SIGNS LIST

F1—first surface
F2—second surface
F3—third surface
F4—fourth surface
F5—fifth surface
F6—sixth surface
1, 1A—solid electrolytic capacitor
10—capacitor assembly
11—capacitor element
19—conductive member
20—first terminal electrode
30—second terminal electrode
40—insulating resin body
60—electrode portion
61—first base electrode
62—second base electrode
63—third base electrode
91—chamber
92—stage
93—aerosol generator
111—electrode foil
112—dielectric layer
113—solid electrolyte layer
400—sealing body
401—top surface
402—bottom surface
403—first end surface
404—second end surface
610—copper powder
620—Sn powder

1. A solid electrolytic capacitor comprising:
a plurality of capacitor elements, each capacitor element having:
a flat film-shaped main body including a valve metal;
a dielectric layer on the flat film-shaped main body; and
a solid electrolyte layer on at least a part of the dielectric layer so as to define a cathode formation region having the solid electrolyte layer and an anode terminal region that does not include the solid electrolyte layer;
a sealing body sealing the plurality of capacitor elements, the sealing body having a first end surface at which an end portion of the anode terminal region is exposed;
a first base electrode on the first end surface and including a first element; and
a second base electrode covering the first base electrode and including the first element and a second element, wherein the second base electrode is an intermetallic compound of the first element and the second element.

2. The solid electrolytic capacitor according to claim 1, further comprising a first terminal electrode covering the second base electrode.

3. The solid electrolytic capacitor according to claim 1, further comprising a third base electrode covering at least a part of the second base electrode and including the second element.

4. The solid electrolytic capacitor according to claim 3, further comprising a first terminal electrode covering the second base electrode or the third base electrode.

5. The solid electrolytic capacitor according to claim 4, wherein the first terminal electrode includes the first element.

6. The solid electrolytic capacitor according to claim 2, wherein the first terminal electrode includes the first element.

7. The solid electrolytic capacitor according to claim 1, wherein:
the sealing body includes a second end surface from which the solid electrolyte layer in the cathode formation region is exposed; and
a second terminal electrode on the second end surface.

8. The solid electrolytic capacitor according to claim 1, wherein the sealing body comprises an insulating resin.

9. The solid electrolytic capacitor according to claim 1, wherein the first element is Cu.

10. The solid electrolytic capacitor according to claim 9, wherein the second element is Sn.

11. The solid electrolytic capacitor according to claim 10, wherein the intermetallic compound is Cu₃Sn.

12. A method of manufacturing a solid electrolytic capacitor, the method comprising:
forming a capacitor element having:
a flat film-shaped main body including a valve metal;
a dielectric layer on the flat film-shaped main body; and
a solid electrolyte layer on at least a part of the dielectric layer so as to define a cathode formation region having the solid electrolyte layer and an anode terminal region that does not include the solid electrolyte layer;
forming a sealing body by stacking a plurality of the capacitor elements and sealing the plurality of capacitor elements with an insulating resin, the sealing body having a first end surface at which an end portion of the anode terminal region is exposed;
forming a first base electrode on the first end surface, the first base electrode including a first element;
forming a third base electrode covering at least a part of the first base electrode, the third base electrode including a second element;
forming a first terminal electrode covering at least a part of the third base electrode, the first terminal electrode including the first element; and
heating and pressing the first terminal electrode on the first end surface on which the third base electrode is formed so as to cause the first base electrode and the third base electrode react with each other and the first terminal electrode and the third base electrode react with each other to form a second base electrode including the first element and the second element.

13. The method of manufacturing solid electrolytic capacitor according to claim 12, further comprising forming a second terminal electrode on a second end surface of the sealing body from which the solid electrolyte layer is exposed.

14. The method of manufacturing solid electrolytic capacitor according to claim 12, wherein the second base electrode is an intermetallic compound of the first element and the second element.

15. The method of manufacturing solid electrolytic capacitor according to claim 14, wherein the first element is Cu.

16. The method of manufacturing solid electrolytic capacitor according to claim 15, wherein the second element is Sn.

17. The method of manufacturing solid electrolytic capacitor according to claim 16, wherein the intermetallic compound is Cu₃Sn.
